(19) United States
(12) Patent Application Publication
(10) Pub. No.: US 2024/0077007 A1
(43) Pub. Date: Mar. 7, 2024

(54) SYSTEM AND METHOD FOR DETECTING A FAILURE IN A FLUID PATH OF A FLUID SYSTEM

(71) Applicants: NOVARES FRANCE, CLAMART (FR); TRIBOSONICS LIMITED, Sheffield South Yorkhire (GB)

(72) Inventors: Nicolas NIVARD, SIMENCOURT (FR); Scott SCHWARTZ, JANESVILLE, WI (US); Chris CORBETT, DELAVAN, WI (US); Philip HARPER, SHEFFIELD (GB); Samuel HILL, YORK (GB); Nicholas WALLIS, SHEFFIELD (GB); Stephen SWAIN, ILKESTON (GB)

(21) Appl. No.: 18/273,804

(22) PCT Filed: Jan. 7, 2022
(86) PCT No.: PCT/FR2022/050036

§ 371 Date: Jul. 24, 2023

(30) Foreign Application Priority Data
Jan. 22, 2021 (FR) FR21/00626

(51) Int. Cl. F01M 11/10

(52) U.S. Cl. CPC F01M 11/10; F01M 2250/00; F16L 2201/10; F16L 2201/30

(57) ABSTRACT

The present disclosure relates to a detection system for detecting a failure in a fluid path of a fluid system, the detection system including: at least one pipe comprising a pipe wall which defines a fluid path for the transfer of fluid and at least one electrically conductive element extending along the at least one pipe and which forms an electrical signal path for a first electrical signal which indicates a state of the at least one pipe; and, an electrical terminal electrically connected to the at least one electrically conductive element so that the first electrical signal is transmitted to the electrical terminal via the electrical signal path.

### CROSS REFERENCE TO RELATED APPLICATIONS

This application is a National Stage of PCT Application No. PCT/FR2022/050036 filed on Jan. 7, 2022, which claims priority to French Patent Application No. 21/00626 filed on Jan. 22, 2021, the contents each of which are incorporated herein by reference thereto.

### TECHNICAL FIELD

The present disclosure relates to systems and methods for detecting a breakdown in a fluid pathway of a fluid system. The present disclosure is particularly useful in the transport sector.

### BACKGROUND

Crankcase ventilation systems remove unwanted gases from the crankcase of an internal combustion engine. The unwanted gases (also known as “blow-by” gases) are gases that have leaked from the combustion chamber to the crankcase through piston rings of the engine. Blow-by gases must be ventilated out of the crankcase otherwise the gases can combine with engine oil vapour that is present in the crankcase to form sludge, and, can cause the engine oil to become diluted with unburnt fuel.

Early internal combustion engines utilised crankcase ventilation systems to vent the blow-by gases to the atmosphere. More recent internal combustion engines utilise a positive crankcase ventilation (PCV) system to send the blow-by gases back into the combustion chamber for mixing with air/fuel mixture and combustion. At present, it is common for national regulators to require new vehicles to be fitted with a PCV system to prevent emissions of blow-by gases to the atmosphere, and thereby reduce hazardous emissions from vehicles.

Typical PCV systems comprise a tube, a one-way valve, and a vacuum source (such as an intake manifold). National regulators often require such PCV systems to be monitored for failure that would cause leakage of the blow-by gases. A current means for providing such monitoring is a gas pressure sensor within the tube. A problem with this arrangement is that the gas pressure sensors do not detect all possible failure modes and the gas pressure sensors are often unreliable.

Recent changes in legislation require that a PCV system malfunction must be detected when any conduit, e.g. a hose, tube, or line that transports crankcase vapours contains a disconnection or break equal to or greater than the smallest internal cross-sectional area of that conduit.

An object of this present disclosure is to provide an alternative or improved detection system, suitable for detecting a breakdown of a fluid pathway of a fluid system.

### BRIEF SUMMARY

The present disclosure provides a detection system and method according to the appended claims.

In particular, the present disclosure relates to a detection system for detecting a breakdown in a fluid pathway of a fluid system, the detection system comprising: at least one conduit comprising a conduit wall which defines a fluid pathway for the transfer of fluid and at least one electrically conductive element extending along the at least one conduit and which forms an electrical signal path for a first electrical signal which is indicative of a condition of the at least one conduit; and, an electrical terminal electrically connected to the at least one electrically conductive element such that the first electrical signal is transmitted to the electrical terminal via the electrical signal path.

In a particular embodiment of the present disclosure, the detection system further comprises at least one connector connected to the at least one conduit and at least one sensor configured to determine a condition of the at least one connector and generate a second electrical signal, said at least one sensor being electrically connected to the at least one electrically conductive element such that the second electrical signal is transmitted to the electrical terminal via the electrical signal path.

In a particular embodiment of the present disclosure, the detection system further comprises a processing unit for receiving the first and/or second electrical signals and monitoring the first and/or second electrical signals for an electrical characteristic which is indicative of a breakdown of the at least one conduit and/or a breakdown or disconnection of the at least one connector respectively.

In a particular embodiment of the present disclosure, the processing unit is configured to determine that a breakdown is present in the at least one conduit or that the at least one connector is fully or partially disconnected using the monitored electrical characteristic.

In a particular embodiment of the present disclosure, the second electrical signal is a sensor electrical signal encoded with data from the at least one sensor and the first electrical signal is a conduit electrical signal encoded with from data relating to the condition of the at least one conduit.

In a particular embodiment of the present disclosure, the conduit electrical signal is applied to the at least one electrically conductive element independently of the sensor electrical signal.

In a particular embodiment of the present disclosure, the electrical characteristic is one or more take from the group comprising: resistance, conductance, capacitance, inductance, frequency response, transit time or amplitude, or a change thereof.

In a particular embodiment of the present disclosure, the at least one electrically conductive element extends along an entire length of the at least one conduit.

In a particular embodiment of the present disclosure, the at least one electrically conductive element extends circumferentially around a surface of the conduit wall of the at least one conduit.

In a particular embodiment of the present disclosure, the at least one electrically conductive element is at least partially embedded within the conduit wall and/or provides an external or internal surface of the at least one conduit.

In a particular embodiment of the present disclosure, the at least one electrically conductive element comprises one or more conductive layers, tapes, films, wires, braids or a conductive polymer.

In a particular embodiment of the present disclosure, the at least one conduit further comprises a plurality of electrically conductive elements.

In a particular embodiment of the present disclosure, the plurality of electrically conductive elements comprises two or more separated electrically conductive elements each configured to form parallel sensing portions of the electrical signal path.

In a particular embodiment of the present disclosure, at least one of plurality of electrically conductive elements is configured to form a return portion of the electrical signal path.

In a particular embodiment of the present disclosure, the processing unit is configured to monitor respective first and/or second electrical signals from each of the plurality of electrically conductive elements for a relative change in the electrical characteristics of the respective first and/or second electrical signals.

In a particular embodiment of the present disclosure, the detection system comprises a plurality of conduits and a plurality of connectors all connected to a common electrical terminal.

In a particular embodiment of the present disclosure, the plurality of conduits extend radially from a common electrical terminal.

In a particular embodiment of the present disclosure, the electrical signal path comprises a sensing portion extending from the electrical terminal to a remote end of the at least one electrically conductive element at a first end of the at least one conduit, and, a return portion extending from the remote end of the at least one electrically conductive element to the electrical terminal.

In a particular embodiment of the present disclosure, the electrical signal path comprises an electrical conductor, which is external to the at least one conduit.

In a particular embodiment of the present disclosure, the external electrical conductor is a chassis of a vehicle.

In a particular embodiment of the present disclosure, the processing unit comprises a bridge circuit.

In a particular embodiment of the present disclosure, the at least one electrically conductive element comprises at least one coil.

In a particular embodiment of the present disclosure, the at least one coil provides a wireless coupling for coupling to the at least one connector and/or the at least one sensor.

In a particular embodiment of the present disclosure, the electrical signal path further comprises a Radio-frequency identification, RFID, chip for transmitting data to or from the electrical terminal and/or the at least one connector.

In a particular embodiment of the present disclosure, the at least one sensor is one or more of: a seal contact pressure sensor, an alignment sensor; an electrical contact sensor in which electrical contacts are made or broken with the connection of the at least one connector; a magnetic sensor in which a magnetic circuit is completed with the connection of the at least one connector; a wireless sensor or an ultrasonic sensor.

In a particular embodiment of the present disclosure, the at least one sensor is embedded in the at least one connector.

In a particular embodiment of the present disclosure, the first and second electrical signals are the same signal.

The present disclosure further relates to a vehicle comprising the detection system as above defined.

In a particular embodiment of the present disclosure, the detection system is part of a positive crankcase ventilation system.

The present disclosure further relates to a method for detecting a condition of a fluid system using the detection system as above defined, and comprising the steps of: receiving a first electrical signal and/or a second electrical signal from at least one electrically conductive element in the at least one conduit; and monitoring the electrical signal for an electrical characteristic which is indicative of a breakdown of the at least one conduit and/or a disconnection of the at least one connector.

In a particular embodiment of the present disclosure, the method further comprises: determining a breakdown in the fluid pathway of the fluid system based on a monitored electrical characteristic.

In a particular embodiment of the present disclosure, the electrical characteristic is one or more take from the group comprising: resistance, conductance, capacitance, inductance, frequency response, transit time or amplitude, or change thereof.

Although the disclosure predominantly relates to a detection system in which there is a sensor which transmits a signal to an electrical terminal via a conduit which forms part of the fluid circuit, it will be appreciated that the disclosure also contemplates a detection system in which there is no sensor and the conductive elements within the conduit may be used to determine the condition of the conduit alone. Hence, the present disclosure provides a detection system for detecting a breakdown in the fluid pathway of a fluid system, the fluid pathway comprising one or more conduits, the detection system comprising: a conduit connected to the connector at a first end and comprising a conduit wall which defines a fluid pathway for the transfer of fluid and an electrically conductive element which forms an electrical signal path for a first electrical signal; and, an electrical terminal in which the electrically conductive element is terminated at a second end of the conduit.

The skilled person will appreciate that except where mutually exclusive, a feature described in relation to any one of the aspects, examples or embodiments described herein may be applied to any other aspect, example, embodiment or feature. Further, the description of any aspect, example or feature may form part of or the entirety of an embodiment of the invention as defined by the claims. Any of the examples described herein may be an example which embodies the invention defined by the claims and thus an embodiment of the invention.

### BRIEF DESCRIPTION OF THE DRAWINGS

The invention will now be described, by way of example only, with reference to the accompanying drawings, in which:

FIG. 1 shows an isometric view of a detection system.

FIG. 2a shows a diagrammatic representation of a first example configuration of the detection system of the present disclosure, particularly, indicating a first configuration of an electrically conductive element and electrical signal path.

FIG. 2b shows a diagrammatic representation of a second example configuration of the detection system of the present disclosure, particularly, indicating a second configuration of an electrically conductive element and electrical signal path.

FIG. 2c shows a diagrammatic representation of a third example configuration of the detection system of the present disclosure, particularly, indicating a third configuration of an electrically conductive element and electrical signal path.

FIG. 2d shows a diagrammatic representation of a fourth example configuration of the detection system of the present disclosure, particularly, indicating a fourth configuration of an electrically conductive element and electrical signal path.

FIG. 2e shows a diagrammatic representation of a fifth example configuration of the detection system of the present disclosure, particularly, indicating a fifth configuration of an electrically conductive element and electrical signal path.

FIG. 2f shows a diagrammatic representation of a sixth example configuration of the detection system of the present disclosure, particularly, indicating a sixth configuration of an electrically conductive element and electrical signal path.

FIG. 2g shows a diagrammatic representation of a seventh example configuration of the detection system of the present disclosure, particularly, indicating a seventh configuration of an electrically conductive element and electrical signal path.

FIG. 2h shows a diagrammatic representation of an eighth example configuration of the detection system of the present disclosure, particularly, indicating a eighth configuration of an electrically conductive element and electrical signal path.

FIG. 3 shows a further diagrammatic representation of an example configuration of the detection system of the present disclosure.

FIG. 4 shows a circuit diagram of an example bridge circuit utilised for sensing a change in resistance caused by deformation of a conductive element of a detection system according to FIG. 1.

FIG. 5 shows a circuit diagram of a further example bridge circuit utilised for sensing a change in resistance caused by deformation of a conductive element of a detection system according to FIG. 1.

FIG. 6a shows a diagram of a smart connector for detecting disconnection between two elements of a detection system according to this disclosure.

FIG. 6b shows a diagram of a smart connector for detecting connection between two elements of a detection system according to this disclosure.

FIG. 7 shows a representation of a sensing conduit of a detection system according to this disclosure.

FIG. 8 shows an example assembly comprising multiple detection systems according to FIG. 1.

FIG. 9 is a flow diagram indicating a method of operating a detection system according to this disclosure.

### DETAILED DESCRIPTION

General Arrangement

The present disclosure and description refer to methods and apparatuses which are employed to determine a condition of a fluid pathway within a fluid system. The condition may be one which may result in or provide the potential for fluid leakage from the fluid system. The condition may be a breakdown of a fluid pathway defined by one or more conduits or connectors.

The breakdown may be mechanical and may comprise a deformation, damage or disconnection of the one or more conduits or connectors. The deformation/damage may include any abnormality shape or thickness of a conduit or conduit wall which is outside of normal operating parameters. The deformation/damage may include an alteration of a cross-section of the conduit or conduit wall at one or more locations caused by, for example, a bulge or other distortion in the conduit wall resulting from a local weakness. The deformation/damage may include a break in the integrity of a wall of the conduit which would result in fluid loss. The break may be an opening such as a hole, split, rupture or a partial or full disconnection or severance of the conduit. The breakdown may be deformation, damage or the partial or full disconnection of a one or more connectors in the fluid system.

The breakdown may result in an opening in the fluid pathway which is at least as great as the smallest cross-section of the fluid pathway defined in the fluid system and/or the conduit and connectors which are monitored by the detection system.

It will be appreciated that the term “fluid” may refer to a liquid, gas or vapour throughout.

Generally, the present disclosure provides a detection system comprising: a sensor; a conduit configured to transfer fluid; and, an electrical terminal; wherein the conduit is configured to conduct an electrical signal from the sensor to the electrical terminal.

More specifically, the present disclosure may provide a detection system for detecting a a breakdown of a fluid pathway in a fluid system, the fluid system comprising one or more conduits and one or more connectors for coupling or terminating the conduits within the fluid system, the detection system comprising: a sensor configured to determine a coupled condition of a connector; a conduit connected to the connector and comprising a wall which defines a fluid pathway for the transfer of fluid and an electrically conductive element which forms an electrical signal path fora first electrical signal; and, a processing unit configured to receive the first electrical signal and monitor the electrical signal for an electrical characteristic which is indicative of a breakdown of the conduit and/or a disconnection of the connector. For example, the processing unit may be configured to determine that a breakdown is present in the conduit or the connector has become fully or partially disconnected using the monitored at least one electrical characteristic.

The electrical signal may be a first electrical signal or a second electrical signal, wherein either of the first or second electrical signal is a sensor electrical signal, and the other of the first or second electrical signal is a conduit electrical signal. The conduit electrical signal may be applied to the electrically conductive element independently of the sensor signal. In one embodiment, the conduit electrical signal may be a voltage which is applied to the at least one electrically conductive element. Monitoring the voltage, for example, the amplitude of the voltage, may provide information relating to the resistance of the electrical conductive element which may change in the event of a breakdown of the conduit. The sensor signal may be provided separately to this signal and may be separately monitored.

The detection system may be provided as part of a fluid system in which a gas, a liquid or a vapour is transported from one location to another in, for example, a vehicle. The fluid system may be hydraulic or pneumatic. The fluid may be a coolant, a lubricant, air, oil, fuel or any other gas, liquid or vapour. Typical uses of the present disclosure may include a crankcase gas ventilation system as described in the background section, a battery pack cooling system, an electrical motor cooling system, a lubrication system, a fuel system, or a hydrogen vehicle cooling system. The system may be part of a conventional internal combustion engine, a hybrid vehicle, an electric vehicle, a hydrogen or fuel cell powered vehicle. It will be appreciated that the detection system may be employed in other applications outside of automotive, such as aerospace or marine vessels, or elsewhere. The detection system may be used to detect leakages or mechanical failures during use of a system and/or may be used to test the assembly of the fluid system to ensure the system does not comprise any leaks prior to each use or following an initial assembly.

The detection system may form part of a monitoring system such as an engine health monitoring system or on-board diagnostic system. Hence, the fluid detection system may monitor the fluid system for leaks, or a potential for leaks, and provide data or a signal indicative of a condition of the fluid system to a larger monitoring system. The data and/or signal captured or determined by the detection system may be used to provide a user with a status of the fluid system. For example, the detection system may provide a signal indicating that there is a potential leak and the location of the leak.

Conduit

The conduit may be configured to transfer fluid from a first location at a first end to a second location at a second end along a fluid pathway as is well known in the art. The conduit may comprise a first end and second end and may be comprise a single part or multiple parts connected together using suitable connections. The sections of the conduit may be connected by suitable connectors, e.g. the sensed connectors described herein, or they may be joined by adhesion, mechanical retention or welding, for example.

The connectors may be two part connectors, such as a male/female connector in which a first male part is sealably inserted into a second female part. The connectors may comprise, for example, compression connectors or push fit connectors having an interference fit and/or one or more sealing elements as well known in the art.

The conduit may be rigid or flexible and may have any desired cross section or length. In many embodiments the cross section of the conduit will be circular with the conduit being generally cylindrical. The conduit may comprise a wall which defines a fluid pathway for the transfer of fluid.

Electrically Conductive Element

As noted above, the conduit may be configured to transmit a signal from a sensor to an electrical terminal. The signal may be an electrical signal and may be transmitted along one or more conductive electrical signal pathways provided within, e.g. as part of, the conduit.

Accordingly, the conduit may include one or more electrically conductive elements embedded within, on or inside a wall of the conduit. The one or more electrically conductive elements may comprise multiple discrete electrical signal paths as described further below. The electrically conductive elements may be provided specifically for the purpose of the detection system, or may be fulfil a dual purpose. In some embodiments, the electrically conductive elements may be used for electrostatic discharge or electromagnetic shielding, for example.

The electrically conductive element may comprise one or more conductive layers, films, wires, braids or a conductive polymer. The electrically conductive element may extend along an entire length of the sensing conduit from a first end to a second end, for example from the sensor to the electrical terminal and/or processing unit.

The electrically conductive element may extend circumferentially around the wall of the conduit so as to at least partially or fully encircle the conduit. Thus, the electrically conductive element may comprise one or more sleeves, tubes or layers within, on or inside the conduit wall. The electrically conductive element may be at least partially embedded within the wall of the conduit and/or provide an internal surface of the conduit and/or overlays and/or over-braids the conduit.

There may be a plurality of electrically conductive elements. The plurality of electrically conductive elements may be distributed circumferentially around the conduit and/or may be distributed radially through the thickness of the conduit wall. Thus, there may be one or more concentrically arranged conductive elements and/or one or more discrete electrically conductive elements extending longitudinally along the length of the conduit. The longitudinally extending electrically conductive elements may be arranged helically or parallel with the longitudinal axis of the conduit.

The electrically conductive element may comprise a conductive polymer or metallic conductive element. The conductive polymer may comprise multiple conductive layers or conductive strips which form part of the conduit wall. The different conductive layers or strips may be used to provide different signal paths which are configured to carry different electrical signals. The conductive polymer may be used for, for example, electromagnetic interference suppression as a primary or secondary function.

The electrically conductive elements may be wires embedded in the wall of the conduit and may be co-extruded. The wires may be over-braided. The electrically conductive elements may be metal tape wrapped around the conduit.

Electrical Characteristics/Sensing of the Conduit

The electrically conductive element may be comprise one or more electrical characteristics which may be monitored by the detection system to determine whether the one or more electrical characteristics change over time. A change in the one or more electrical characteristics may be indicative of a breakdown of the conduit. The breakdown may be a change in the shape of the conduit such as an expansion (e.g. a bulging caused by a failure in the structural integrity of the conduit wall) or compression (e.g. an unintended or undesirable compression), or a rupture in which an opening in the wall of the conduit occurs. The breakdown may comprise a complete rupture or disconnection of two parts of the conduit at a connector or within a continuous length of conduit wall.

The monitoring of the electrical characteristics of the conduit may allow the fluid system to detect a complete break in the conduit resulting in a total loss of an electrical signal. Alternatively or additionally, the monitoring of the conduit may allow damage to be detected by a loss of signal in one or more of the signal pathways or a change in an electrical characteristic (other than a loss of signal).

The at least one electrical characteristic may be one or more taken from the group comprising: resistance, conductance, capacitance, inductance, or amplitude, for example. However, others as known in the art may be employed in some embodiments.

The electrical characteristic may also be monitored to detect a change in the characteristic over time, rather than simply monitoring the instantaneous or absolute value.

Electrical Terminal

The electrical terminal may be electrically connected to the conduit and/or an electrically conductive element which passes through or along the conduit to provide the electrical signal from the sensor. The electrical terminal may provide a connection point to connect the electrically conductive element to a monitoring system via external wiring or a wireless link. The external wiring may send or receive electrical signals to or from the sensor via the electrical terminal and conduit and/or may send a signal which is indicative of the condition of the conduit.

The electrical terminal may comprise a housing in which one or more electrical terminals or electrical connections are provided as is well known in the art.

The electrical terminal may be mounted on a connector of the fluid system or a surrounding structure. Where the electrical terminal is mounted on a connector, this may be referred to as a terminal connector or interface connector. The connector in which a sensor is provided may be described as a remote connector or sensing connector. It will be appreciated that the terminal connector may also include one or more sensors as part of the detection system.

Processing Unit

In some embodiments, the electrical terminal may comprise a processing unit configured to receive the electrical signal from the sensor. Additionally or alternatively, the processing unit may be configured to monitor at least one electrical characteristic of the conduit. Additionally or alternatively, the processing unit may be configured to determine a condition of the conduit or a connector to which the sensor is mounted. In some embodiments the processing unit may located remotely from the electrical terminal. Thus, the processing unit may form part of a different or larger monitoring system such as an on board diagnostic system. Thus, the electrical signal from the conduit or sensor may be passed to the processing unit via the electrical terminal, or the electrical terminal may include the processing unit which outputs either an alert, or a signal which is indicative of the condition of the conduit or connector.

The processing unit may be configured to determine a leak condition in the conduit using the monitored at least one electrical characteristic. The leak condition may be determined from electrical signals received from the sensor or from the conduit. The leak condition may correspond to a breakdown of the conduit or a disconnection (total or partial) of one or more connectors.

The processing unit may be configured to process one or more ultrasonic signals (e.g. signals from an ultrasonic transducer) and/or one or more electrical signals and/or one or more electrical characteristics.

The ultrasonic signals may be based on conventional sensing technologies such as a continuous or pulsed wave excitation or resonance.

Where multiple electrically conductive elements are provided as part of a conduit, the multiple elements may be joined together such that a break in one or more of the electrically conductive paths provides a step-change in an electrical characteristic or signal which is being transmitted down the multiple electrically conductive paths. This may be make the detection of damage easier to detect.

The multiple electrically conductive elements may be separately monitored. The multiple electrically conductive elements may be monitored to determine relative changes in the electrically conductive elements using, for example, a bridge circuit.

The electrical signals/characteristics may comprise monitoring the resistance to ground measurement using conductors used for ESD and/or EMI purposes.

In addition to the electrically conductive elements provided in the conduit, the detection system may utilise extraneous conductive paths such as, for example, the chassis of a vehicle for a return path. The multiple electrically conductive elements may include one or more electrically conductive element for a return path (e.g. ground).

In various embodiments, the processing unit may comprise: control circuitry; and/or processor circuitry; and/or at least one application specific integrated circuit (ASIC); and/or at least one field programmable gate array (FPGA); and/or single or multi-processor architectures; and/or sequential/parallel architectures; and/or at least one programmable logic controllers (PLCs); and/or at least one microprocessor; and/or at least one microcontroller; and/or a central processing unit (CPU) to perform the methods. The processing unit may be executed in hardware or software, for example.

The external connector may also comprise one or more memories. The one or more memory may comprise a non-transitory computer readable storage medium comprising computer readable instructions that, when read by the processing unit, configure the processing unit to carry out the methods described herein. The computer readable instructions may comprise executable code relating to the monitoring or determination or categorisation of the conduit or a leak, for example. The one or more memory may comprise: volatile memory, for example, one or more dynamic random access (DRAM) modules and/or static random access memory (SRAM) modules; and/or non-volatile memory, for example, one or more read only memory (ROM) modules, which for example may comprise a Flash memory and/or other electrically erasable programmable read-only memory (EEPROM) device.

Connectors

The conduit may be terminated with or include one or more connectors which join an end of the conduit to another element in the fluid system, or join two portions of conduit together. The connector may be referred to as a fluid connector as it connects the fluid pathway, however, the fluid connector may also include electrical elements as part of the electrical signal pathway and/or electrically conductive element used to transmit electrical signals from the sensor to the electrical terminal. As noted above, the connectors may comprise, for example, compression connectors or push fit connectors having an interference fit and/or one or more sealing elements as well known in the art.

There may be a plurality of connectors. Each of the plurality of connectors may be associated with a different conduit. The plurality of conduits may be arranged in series, parallel or a radial arrangement. The plurality of conduits may belong to discrete systems may or may not relate to the same fluid system. Thus, there may be a plurality of conduits and/or connectors which are electrically connected to a common electrical terminal and/or processing unit.

Providing a single electrical terminal and/or processing unit for a number of sensors or sensing conduits can reduce the infrastructure required to implement the detection system.

The connectors and conduit may include alignment features which only allow mating in a predetermined orientation such that any sensors used to detect the mating of the connector can be placed in discrete locations to allow for alignment of corresponding parts in the sensor.

The electrical connection between sections of conduit and/or the connectors may be provided by a conductive connection having a low resistance interface to allow efficient transmission of any electrical signals. The electrical connection may include multiple sets of connectors to provide discrete electrical pathways. As noted above, the pathways may include one or more signal pathways and one or more return pathways.

The electrical connection and/or sensor may include one or more coils for inductive coupling across the connector. In some embodiments, the electrical connection may be provided by a conductive epoxy or the like in the connection interface. Other mechanical elements may be included to help bridge the connection, such as conventional electrical contacts which contact electrically conductive element within or on the conduit, such as an over braid.

Sensor

The connectors may comprise one or more sensors for sensing the mating of the connectors such that a partially or full disconnection of the connector and/or the potential for a leak associated with the connector may be determined. The sensor may be any suitable sensor as known in the art and may comprise, for example, a transducer, electrical contacts, or a magnetic sensor.

The sensor may be configured to determine a seal contact pressure and or an alignment of the connector parts (e.g. an alignment along an insertion axis of the connector parts). In the case of a seal contact pressure, the sensor may comprise one or more of an ultrasonic sensor or a force measurement sensor. The force measurement sensor may be an ultrasonic sensor in which the ultrasonic response of the connector is measured allowing the contact pressure to be determined, or an electrical sensor such as a strain gauge or the like is used to determine the contact pressure.

The alignment sensor may comprise one or more of an electrical, magnetic or ultrasonic sensor. The alignment sensor may comprise an wireless sensor such as an induction coil or electrical contacts which mate when the connector is fully inserted.

The sensor may transmit a signal to the electrical terminal using the conduit, as described above. The sensor may also receive one or more electrical signals via the conduit.

The sensor may be provided as part of a sensing unit which is discretely manufactured and attached to a connector prior to, during, or after the assembly of the fluid system.

The sensor may comprise a sensor housing which is configured to be mated or coupled to a connector by one or more fixtures or connecting portions. For example, the sensor may be a collar in which an external surface of the connector is received by way of an interference or compression fit. The sensor housing may be attached by one or more fixtures such as a strap, tie, bolt, adhesive or clip, for example.

Operation

As noted above, the operation of the detection system may comprise receiving a signal from a sensor placed in a connector of the conduit. The signal may be monitored to determine an electrical characteristic of the signal (which corresponds to a state or electrical characteristic of the conduit or sensor) or a change in the signal. The change in the signal may be change in amplitude or full loss of signal due to the breakdown or disconnection of the conduit or connector. In some embodiments, the frequency content and/or phase and/or timing of the signal may change. In some embodiments, electrical signals may be injected into the conduit and monitored for a change. For example, a voltage may be applied to one or more electrically conductive elements to determine and the voltage monitored to determine whether the electrical characteristics of the conduit have changed. The injected signal may be separate to a signal transmitted to or received from sensor.

When a change in an electrical characteristic is detected, the cause of the change may be determined and an assessment made as to whether this is indicative of a leak in the system, or, in some embodiments, whether the system has degraded to such that the potential for a leak may be increased.

A suitable alert may be provided to a user of the system or machinery in which the system is installed, e.g. a vehicle, such that appropriate action can be taken.

### Specific Embodiments

Described below are a number of specific embodiments in connection with the drawings. It will be appreciated that the features of the specific embodiments may be used interchangeably where technically feasible to provide intermediate embodiments.

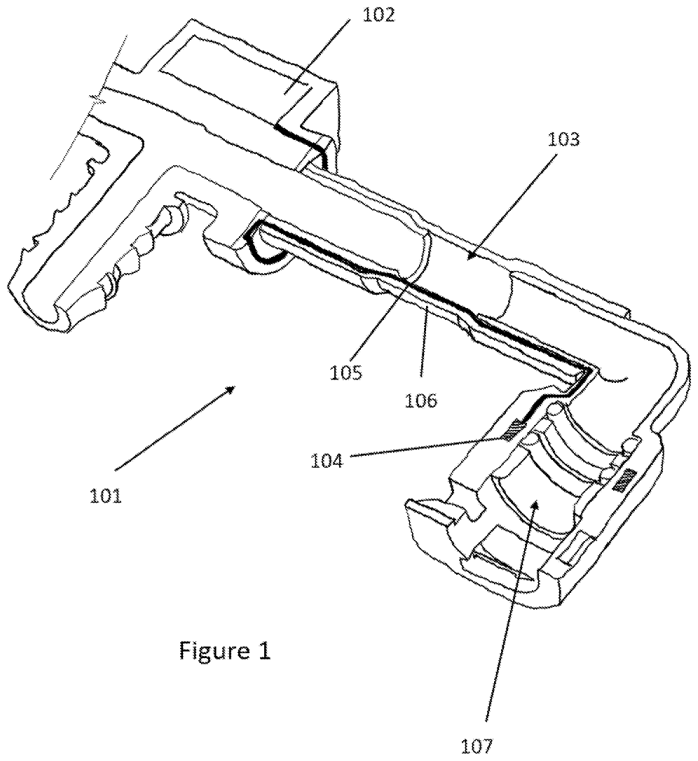

With reference to FIG. 1, there is provided an improved detection system that is suitable for use as a positive crankcase ventilation system (PCV) 101. The detection system includes an electrical terminal 102 (which may also be referred to as a communication interface), a conduit 103, and a sensor 104. The electrical terminal and sensor 104 may be electrically connected via the conduit 103. As can be seen, the electrical connection may be achieved with one or more conductive elements 105 which are provided as part of the conduit 103.

The electrical terminal 102 may be in communication with, or interface with, an on-board diagnostics system (OBD) (not shown) of a vehicle, for example. The OBD may be configured to provide a user (e.g. the driver of the vehicle or a mechanic) with an alert relating to one or more vehicle systems. The alert may relate to a condition of the fluid system for which the detection system is provided to monitor. The condition may be a change in pressure or a loss of pressure, for example. The condition may be indicative of a leak in the system. The leak may be caused by a breakdown in one or more conduits or connectors, such as a rupture in the wall of a conduit and/or a full or partial disconnection causing leakage of fluid.

The electrical terminal 102 may be electrically connected to the sensor 104 with an electrically conductive element 105. The electrically conductive element 105 may be part of or coupled to a wall 106 of a conduit 103. In one embodiment, the conduit 103 may be suitable for transferring gases from a crankcase (now shown) to a combustion chamber (not shown) of an internal combustion engine (not shown).

In the example of FIG. 1, the sensing conduit 103 is tubular having a circular cross section, however the conduit 103 could be any suitable shape for transferring gas or other fluid. The conduit 103 can be manufactured from any suitable material which may be a conductive material, such as a conductive polymer, or an insulating material for insulating the electrically conductive element 105. The conductive element 105 forms an electrical signal path between the electrical terminal and the sensor.

The electrical terminal 102 may be include one or more processing unit configured to inject an electrical signal into the signal path and to monitor for a change in the electrical signal caused by a deformation or breakage of the conductive element 105 for indicating damage to the wall of the sensing conduit 103. As will be discussed below, the conductive element 105 may be coupled to the wall 106 in such a manner so as to undergo breakage or deformation when there is damage to the wall 106. Such breakage or deformation in the conductive element 105 may cause a change in the electrical characteristics of the conductive element 105 and or the signal travelling along the signal path (through the conductive element 105). The change in the electrical characteristic and/or the electrical signal may be detected by the electrical terminal 102, enabling the user to be alerted via the electrical terminal that there is a rupture in the wall 106.

A rupture in the wall 106 of the conduit 103 could be detected based on a complete loss of electrical signal or other change in electrical characteristics over the signal path, for example. The system may be able to either detect a complete break in the conduit, or, damage such as a hole or thinning of the conduit wall.

It has been found that this mechanism of detecting damage/ruptures is more reliable and improved over traditional PCV systems that utilise pressure sensors for detecting damage/ruptures based on a change in pressure of gases. Detection systems according to this disclosure are able to detect ruptures that are smaller than those which are detectable using pressure sensors. In particular, the present detection system is able to detect ruptures that have a size equal to or greater than the smallest internal cross-sectional area of the conduit 103.

The electrically conductive element 105 may be manufactured from a metallic material. In this instance, the conductive element 105 may comprise any of: wires, tapes, films or layers embedded in the wall of the conduit 103 or overlaid or over-braided on the conduit 103. The conductive element may comprise, for example, a metal tape wrapped around the conduit 103 or any other alternatives described herein or known in the art. The conductive element 105 may comprise multiple conductors for providing multiple signal paths. The multiple conductors may be provided as part of a laminated or layered conduit wall in which conductive layers are radially separated through the thickness of the conduit wall, as described in more detail below.

The electrically conductive element 105 may be manufactured from a conductive polymer. In this instance, the electrically conductive element 105 may comprise any of: multiple conductive layers within the wall 106; and multiple strips of conductive material to provide multiple signal paths. The multiple conductive layers may be configured to provide for suppression of electromagnetic interference.

In the example of FIG. 1, there is additionally shown an optional connector 107, which may be referred to as a smart connector. The connector 107 may comprise the sensor 104 for determining a connection condition of the connector 107. Thus, the sensor 104 may be configured to send a signal to the electrical terminal 102 which is indicative of the connection condition and whether there is a partially or full disconnection of the connector or an misalignment for example.

The sensor 104 may comprise a wireless sensor electrically connected to the signal path. The sensor 104 may be configured to sense an alignment of the conduit 103 with the smart connector 107 and change an electrical property of the signal when the alignment is adjusted away from a default position. The connector 107 may provide the ability to detect a disconnection of the conduit 103 from other parts of the system, which would cause leakage of fluid. The sensor 104 may utilise induction wireless coils or detection of electrical contacts mating, as will be discussed in more detail below.

The sensor 104 may be housed within a sensor housing. The sensor housing may be configured to be separate from the connector 107 and fit around the connector 107 such that the sensor 14 can be located in an appropriate location for sensing the condition of the connector 107. As can be seen from FIG. 1, the sensor housing may comprise a collar which encircles an external surface of the connector 107 so as to receive the connector snugly within, via an interference fit, for example.

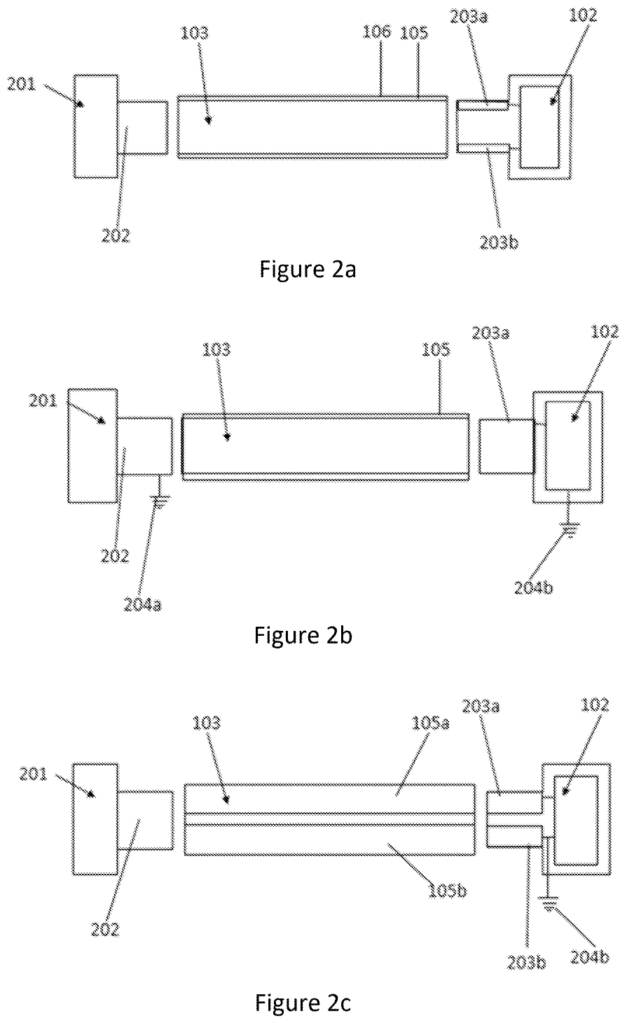

Various possible configurations of the detection system as described with reference to FIG. 1 will now be described with reference to FIGS. 2a-2h.

With reference to FIG. 2a, the electrically conductive element 105 is in the form of an internal layer, e.g. a coating, of a conduit 103. The internal layer may be exposed to or directly contact the fluid within the conduit 103 in use, for example. The electrical terminal 102 may be located at one end of the conduit 103 and may be electrically coupled to the electrically conductive element 105 via two local conductive regions 203a, 203b.

The detection system may comprise a remote connector 201 (which may be equivalent to the connector 107 of FIG. 1), which is located an opposite end of the conduit 105 to the electrical terminal 102 comprising a processing unit. The remote connector 201 may comprise a remote conductive region 202. In such an arrangement, the electrical signal path is formed by the two local conductive regions 203a, 203b, the electrically conductive element 105, and, the remote conductive region 202. The remote conductive region may include a ground connection (not shown) to provide for static discharge, as known in the art.

When there is a rupture in the conduit wall 106, or, a disconnection between either the remote connector 201 and the conduit 103 or the electrical terminal 102 and the conduit 105, then there is an alteration to the signal path causing a change of one or more electrical characteristics that can be detected by the electrical terminal 102. In the particular configurations of FIGS. 2a-h, the electrical terminal 102 may comprise a resistance monitor and detection of a rupture in the conduit wall 106 or disconnection may be based on a measurement of a change of resistance across the signal path. The configuration of FIG. 2a has been found to be more effective at detecting ruptures that are located closer to the electrical terminal 102, in comparison to those that are located further away from the electrical terminal 102.

With reference to FIG. 2b, an alternative configuration to FIG. 2a is presented with reference numerals corresponding to the same features discussed above. There is a single local conductive region 203a connected to the electrically conductive element 105, which is in the form of an internal conductive layer. There are two ground connections 204a and 204b connected to the remote conductive region 202 and electrical terminal 102 respectively. The signal path is formed by the local conductive region 203a, the electrically conductive element 105, the remote conductive region 202 and the region between the ground connections 204a and 204b. The signal path can be considered to comprise a sensing portion (in this case, from the electrical terminal 102 up to the ground connection 204a), and, a return portion (in this case, from the ground connection 204a to the ground connection 204b).

As used herein, the term “sensing portion” may refer to a portion of the signal path extending across the conduit 105 to an end of the conduit 105 opposite to the electrical terminal 102. The term “return portion” may refer to a portion of the signal path “returning” to the electrical terminal 102 from the end of the conduit 103 opposite to the electrical terminal 102. The “return portion” of the signal path may or may not be configured to provide sensing capability. In the example of FIG. 2b, the return portion of the signal path is between the ground connections 204a, 204b, and therefore is typically across ground elements such as a chassis of a vehicle. A particular advantage of the configuration of FIG. 2b is that ruptures along the entire length of the conduit 105, or, disconnections at either end of the conduit 105, are substantially equally detectable.

With reference to FIG. 2c, an alternative configuration to FIG. 2a is presented with reference numerals corresponding to the same features discussed above. The electrically conductive element comprises two separate electrically conductive elements 105a and 105b. The electrical terminal 102 comprises two local conductive regions 203a, 203b for connection to the corresponding separate electrically conductive elements 105a, 105b. The signal path is formed by the circuit provided by the local conductive region 203a, the electrically conductive element 105a, the remote conductive region 202, the electrically conductive element 105b, and the local conductive region 203b. There is a single ground connection 204b connected to the interface connector 102. In this configuration, both of the sensing and return portions of the signal path are located along the conduit 103, and there is no reliance on a chassis ground connection for the return portion as per the configuration of FIG. 2b. The electrically conductive elements 105a, 105b may be segmented internal conductive coatings applied to an internal surface of the conduit 103.

The configuration of FIG. 2d is similar to that of FIG. 2c with the inclusion of a grounding connection 204a connected to the remote conductive region 202. In this configuration, the grounding connection 204a includes a grounding resistor for ensuring that the ground connection does not interfere with the return portion of the signal path. The grounding connection 204a at this location provides for static discharge from the remote conductive region 202.

The configuration of FIG. 2e is similar to that of FIG. 2b, with the exception that there are two electrically conductive elements 105a, 105b in the form of multiple layers of conductive coating providing multiple parallel signal paths for the sensing portion of the signal path. In examples, there are more than two electrically conductive elements.

The configuration of FIG. 2f is similar to that of FIG. 2e, with the exception that each of the two multiple electrically conductive elements are individually connected to a different channel 205a, 205b at the electrical terminal 102 via a different local conductive regions 203a, 203b respectively. Therefore, the electrical properties across each of the electrical conductive elements 105a, 105b can be measured separately. For example, when the electrical terminal 102 is configured to measure resistance, then the resistance of each conductive element 105a, 105b can be compared. If only one resistance changes, then it is possible to detect particularly small ruptures.

The configuration of FIG. 2g is similar to that of FIG. 2c, with the exception that there are two parallel electrically conductive elements 105a, 105b forming the sensing portion of the signal path. The electrically conductive elements 105a, 105b are connected to the electrical terminal 102 via corresponding channels 205a, 205b. Additionally, there is a third electrically conductive element 105c providing the return portion of the signal path, and connected to a ground channel 205c. The ground channel 205c is additionally electrically connected to ground connection 204b. The electrically conductive elements 105a, 105b, 105c may comprise conductive strips of material, and ruptures in the conduit wall 106 of similar size to the width of the strips are detectable. Sensitivity of the detection is improved by comparing electrical properties (such as resistance) measured for each channel.

The configuration of FIG. 2h is similar to that of FIG. 2e, with the exception that there are more than two electrically conductive elements 105a, 105b, 105c in parallel along the sensing portion of the signal path.

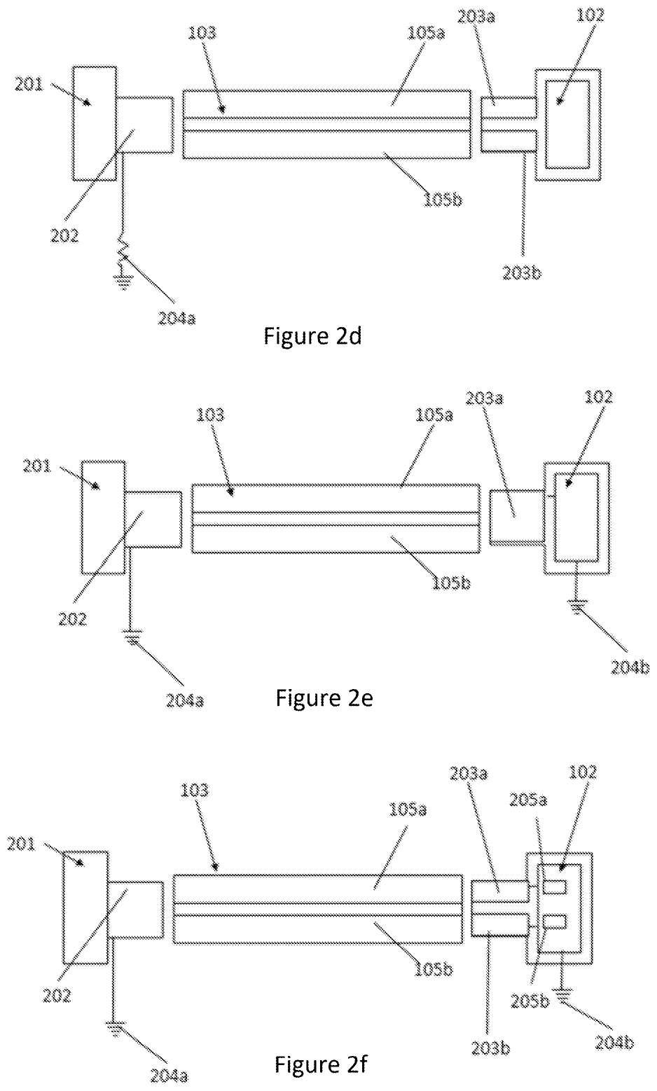

With reference to FIG. 3, there is provided a detection system which utilises a wireless connection between the conduit and either or both of the electrical terminal and smart connector.

Thus there is shown a detection system which may comprise an electrical terminal 102, electrically conductive elements 105a, 105b in the form of wire coils around a conduit 103, and a remote connector 201. The electrical terminal 102 and remote connector 201 are located at opposing ends of the conduit 103. The electrically conductive elements 105a, 105b form a coil at regions 301a and 301b proximate the ends of the conduit 103 to provide wireless transmission via inductive coupling between the conduit 103 and the electrical terminal 102 and/or remote connector 201.

The inductive coupling coils provide an electrical communication path to transfer a Radio-frequency identification (RFID) frequency data (and power) between an RFID chip 302 located at the electrical terminal 102 and an RFID tag 303 located at the remote connector 201. The coil is preferably resonant at a frequency generated by the RFID chip.

A breakage/rupture in the conduit 103 may causes a fault in the conductive elements provided along the conduit, thereby disabling or altering the data signal received of the RFID tag 303 by the RFID chip 302, hence providing detection of the breakage. Furthermore, disconnection of the conduit from either the electrical terminal 102 or the remove connector 201 disables reading of the RFID tag 303, hence causing an alert.

The conductive element which is part of the conduit is shown as being helically arranged but it will be appreciated that other arrangements of conductive elements as described herein may be possible.

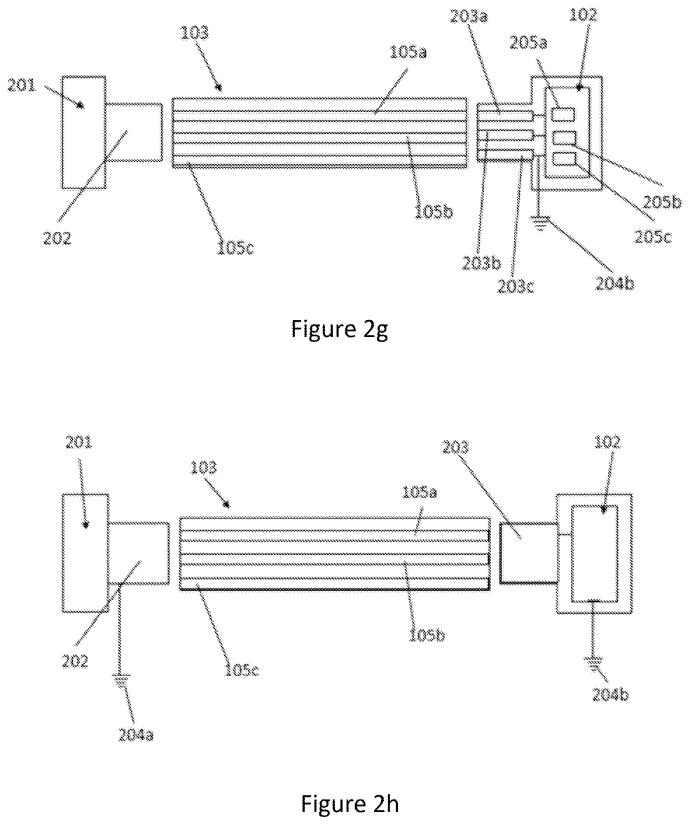

With reference to FIG. 4, the electrical terminal 102 may comprise a processing unit in the form of an analogue-to-digital converter 401. The analogue-to-digital converter 401 may comprise a voltage reference output VrefOutput configured to provide a predetermined voltage, a voltage input Vin, and a ground signal input SigGnd. The converter 401 is connected via these inputs/outputs to a bridge circuit 402 which are well known in the art.

VrefOutput may be electrically connected to a first branch of the bridge circuit 402 comprising a series resistor RA. SigGnd may be electrically connected, via an electric ground such as a chassis of a vehicle, to a second branch of the bridge circuit 402 comprising a resistor RB, which corresponds to an electrically conductive element as described above. Vin may be connected to a third branch of the bridge circuit 402 that is electrically connected between the ends of the first and second branches. The converter 401 is configured to determine a resistance across the electrically conductive element based on a measurement of the voltage Vin from the third branch of the bridge circuit 402, and, the predetermined voltage output VrefOutput. In particular, Vin is calculated by the following mathematical equation:

Vin=RB/(RA+RB)×Vref

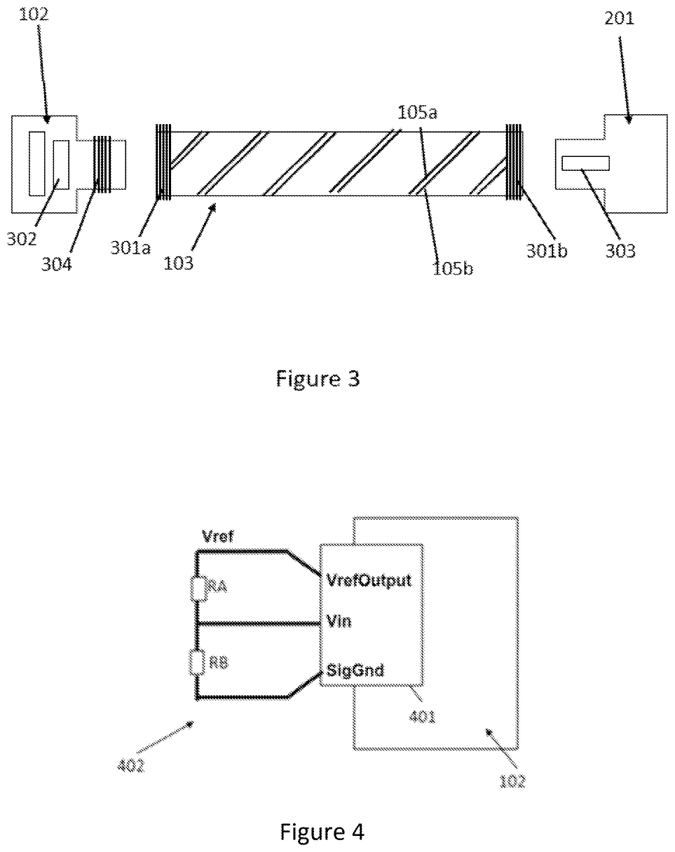

FIG. 5 shows an example electrical terminal 102 and circuit construction that is similar to that described with respect to FIG. 4, however there are multiple resistances RB1, RB2, RBN+1, corresponding to multiple electrically conductive elements, which may correspond to multiple conductive elements coupled to the conduit as described above e.g. with reference to FIG. 2g, 2h and described elsewhere. Each electrically conductive element corresponding to the resistances RB1, RB2, RBN+1 is in series with a second branch of a corresponding bridge circuit 402a, 402b, 402c. Each of the bridge circuits includes a corresponding series resistor on the respective first branch RA1, RA2, RAN+1. Each of the bridge circuits provides a corresponding voltage input VinA, VinB, VinN for measurement by the converter 401. Therefore, the resistances RB1, RB2, RBN+1 can each be monitored separately providing a high level of accuracy for determining ruptures in a conduit as described above.

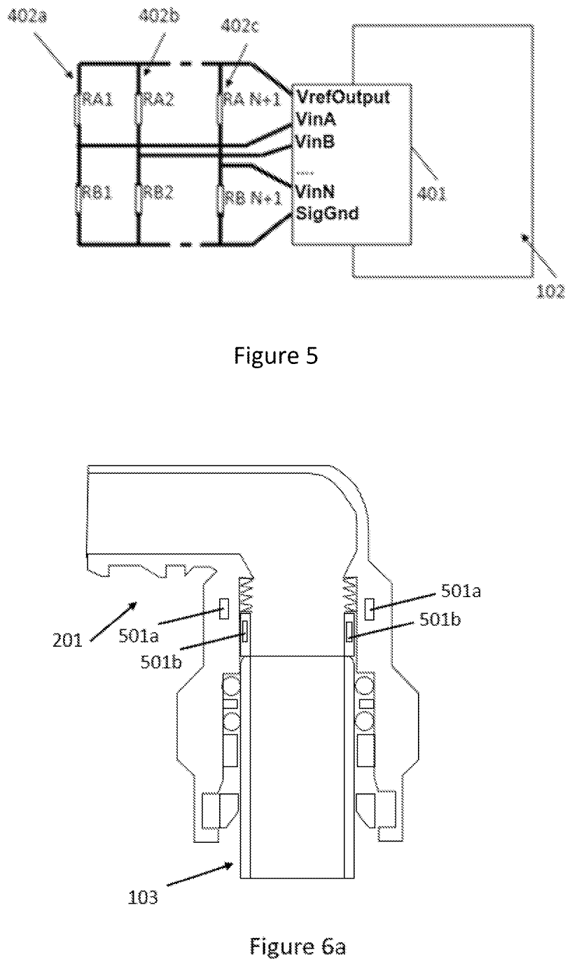

With reference to FIGS. 6a and 6b, a remote connector 201 is connected to a conduit 103. The connection comprises a wireless interface including first wireless detectors 501a located on the remote connector 201 and second wireless detectors 501b located on the conduit 103. The detectors 501a, 501b may be electrically connected to an electrical terminal as described above (not shown). The detectors 501a, 501b may be connected to the electrical terminal via the electrically conductive elements, and, may form part of the signal path described above.

With particular reference to FIG. 6a, the wireless detectors 501a, 501b are out of alignment and therefore a disconnection condition is detected for generating an alert to a user. With particular reference to FIG. 6b, the wireless detectors 501a, 501b are in alignment and therefore there is no disconnection condition detected. The wireless detectors 501a, 501b as represented herein may be applied to any connector attached to the conduit either upstream or downstream of the gas flow for detecting any disconnection of the conduit at either end. In examples, the detectors 501a, 501b comprise embedded conductive coils, such that when current is applied to at least one of the detectors, a different electrical signal is returned depending on the alignment of the coils. Alternatively, the detectors 501a, 501b may function by relying on detection of an electrical contact that is disconnected when the detectors move out of alignment with each other.

It will be appreciated that the detectors used to determine the connection status of the remote connector may be magnetic (such as a reed switch, for example) or may be electrical contacts which become electrically contacted following sufficient insertion of the conduit into the connector or the connector on to a different element. The electrical connection may be made by the inserted mating connector 103 displacing or deforming an electrically conductive structure or feature.

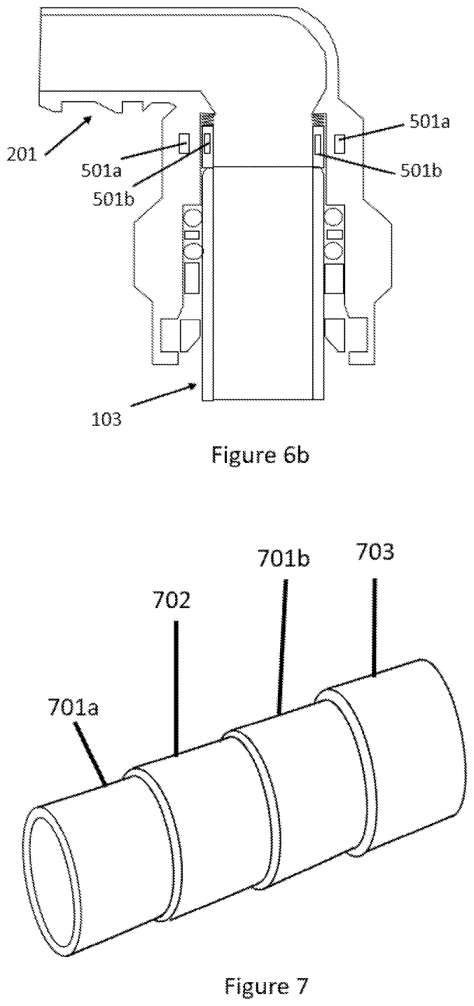

A sensing conduit as described herein may be coupled with electrically conductive elements in accordance with the structure shown in FIG. 7. With reference to FIG. 7, there are multiple layers of electrically conductive elements 701a, 701b. An insulating layer 702 is between the layers of electrically conductive elements 701a, 701b. An outer layer 703 is external to the sensing conduit.

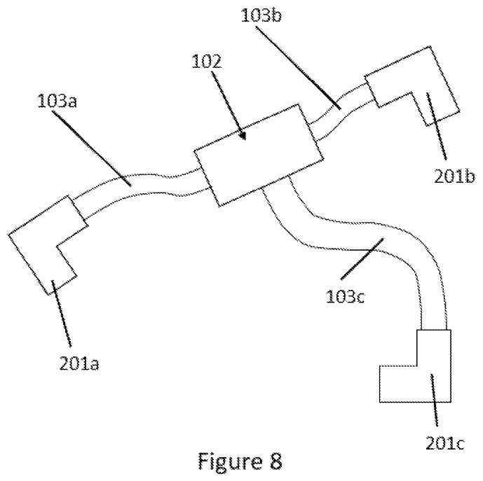

With reference to FIG. 8, a detection system may comprise multiple sensing conduits (each as described herein) 103a, 103b, 103c that are each coupled to a central electrical terminal 102, as described herein. Each of the sensing conduits 103a, 103b, 103c may be connected to a corresponding remote connector 201a, 201b, 201c. The assembly provides a modular assembly that can be adapted for multiple different types of geometry. A breakage or disconnection of any sensing conduit 103a, 103b, 103c, can be detected by a single electrical terminal 102 thereby reducing the number of connections/cabling, and, reducing installation cost. The assembly shown in FIG. 8 is a radial arrangement but others are possible.

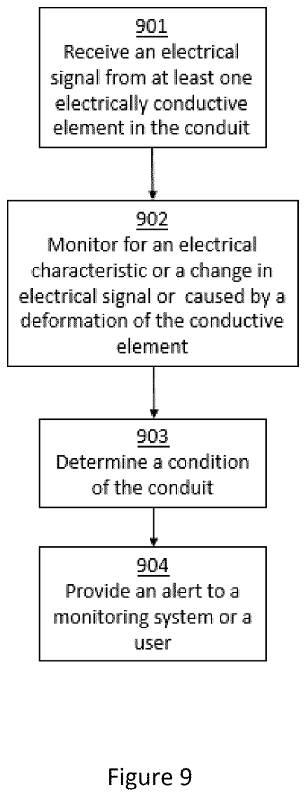

With reference to FIG. 9, a method operating a detection system according to this disclosure comprises, at step 901, receiving an electrical signal from at least one electrically conductive element in the conduit. The electrical signal may be a signal provided from a sensor which senses the condition of a connector and/or an electrical signal injected into an electrically conductive element of the conduit for monitoring the condition of the conduit.

At step 902, the electrical signal is monitored for an electrical characteristic or a change in the electrical signal or caused by a deformation of the conductive element. At step 903, a determination may be made as to whether a monitored change is indicative of a change in the condition of the conduit, such as a deformation in the shape of the conduit (such as a rupture), or a disconnection in the conduit of a connector.

At step 904, an alert may be provided to a monitoring system or user. The alert may correspond to the detected change.

It will be appreciated that the processing unit described herein and which is located local to the connectors and conduit may simply provide an output signal which is representative of a change in the monitored condition, rather than an alert per se. Thus, the determination of step 903 and the provision of the alert may be carried out by a different processing unit which is part of a different or larger system of which the detection system is part.

The detection systems as described herein have been found to perform favourably, particularly when subject to external conditions such as bending of the conduit, presence of water, and high temperature—e.g. 80 degrees C. Where the monitored electrical property is resistance across the electrically conductive element, the constructions described above provide for a correlation between a size of rupture in the conduit and level of resistance measured by the electrical terminal. It would therefore be possible for a user to use the present system to ascertain the severity of any rupture or other damage to the conduit.

The detection systems discussed herein are not limited to application with positive crankcase ventilation systems. Other example uses include detection in fluid systems for critical fluids for battery pack cooling systems, e-motor cooling systems (including system tubes and connectors), hydrogen fuel systems, and hydrogen vehicle cooling systems.

It will be understood that the invention is not limited to the examples and embodiments above described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A detection system for detecting a breakdown in a fluid pathway of a fluid system, the detection system comprising:
at least one conduit comprising a conduit wall which defines a fluid pathway for the transfer of fluid and at least one electrically conductive element extending along the at least one conduit and which forms an electrical signal path for a first electrical signal which is indicative of a condition of the at least one conduit; and,
an electrical terminal electrically connected to the at least one electrically conductive element such that the first electrical signal is transmitted to the electrical terminal via the electrical signal path.

2. The detection system according to claim 1, further comprising at least one connector connected to the at least one conduit and at least one sensor configured to determine a condition of the at least one connector and generate a second electrical signal, said at least one sensor being electrically connected to the at least one electrically conductive element such that the second electrical signal is transmitted to the electrical terminal via the electrical signal path.

3. The detection system according to claim 2, further comprising a processing unit for receiving the first and/or second electrical signals and monitoring the first and/or second electrical signals for an electrical characteristic which is indicative of a breakdown of the at least one conduit and/or a breakdown or disconnection of the at least one connector respectively.

4. The detection system according to claim 3, wherein the processing unit is configured to determine that a breakdown is present in the at least one conduit or that the at least one connector is fully or partially disconnected using the monitored electrical characteristic.

5. The detection system according to claim 2, wherein the second electrical signal is a sensor electrical signal encoded with data from the at least one sensor and the first electrical signal is a conduit electrical signal encoded with from data relating to the condition of the at least one conduit.

6. The detection system according to claim 5, wherein the conduit electrical signal is applied to the at least one electrically conductive element independently of the sensor electrical signal.

7. The detection system according to claim 3, the electrical characteristic is one or more characteristic(s) chosen from the group comprising: resistance, conductance, capacitance, inductance, frequency response, transit time or amplitude, or a change thereof.

8. The detection system according to claim 1, wherein the at least one electrically conductive element extends along an entire length of the at least one conduit.

9. The detection system according to claim 1, wherein the at least one electrically conductive element extends circumferentially around a surface of the conduit wall of the at least one conduit.

10. The detection system according to claim 1, wherein the at least one electrically conductive element is at least partially embedded within the conduit wall and/or provides an external or internal surface of the at least one conduit.

11. The detection system according to claim 1, wherein the at least one electrically conductive element comprises one or more conductive layers, tapes, films, wires, braids or a conductive polymer.

12. The detection system according to claim 2, wherein the at least one conduit further comprises a plurality of electrically conductive elements.

13. The detection system according to claim 12, wherein the plurality of electrically conductive elements comprises two or more separated electrically conductive elements each configured to form parallel sensing portions of the electrical signal path.

14. The detection system according to claim 12, wherein at least one of plurality of electrically conductive elements is configured to form a return portion of the electrical signal path.

15. The detection system according to claim 12, further comprising a processing unit for receiving the first and/or second electrical signals and monitoring the first and/or second electrical signals for an electrical characteristic which is indicative of a breakdown of the at least one conduit and/or a breakdown or disconnection of the at least one connector respectively and wherein the processing unit is configured to monitor respective first and/or second electrical signals from each of the plurality of electrically conductive elements for a relative change in the electrical characteristics of the respective first and/or second electrical signals.

16. The detection system according to claim 1, comprising a plurality of conduits and a plurality of connectors all connected to a common electrical terminal.

17. The detection system according to claim 16, wherein the plurality of conduits extend radially from a common electrical terminal.

18. The detection system according to claim 1, wherein the electrical signal path comprises a sensing portion extending from the electrical terminal to a remote end of the at least one electrically conductive element at a first end of the at least one conduit, and, a return portion extending from the remote end of the at least one electrically conductive element to the electrical terminal.

19. The detection system according to claim 1, wherein the electrical signal path comprises an electrical conductor, which is external to the at least one conduit.

20. The detection system according to claim 19, wherein the external electrical conductor is a chassis of a vehicle.

21. The detection system according to claim 3, wherein the processing unit comprises a bridge circuit.

22. The detection system according to claim 1, wherein the at least one electrically conductive element comprises at least one coil.

23. The detection system according to claim 22 further comprising at least one connector connected to the at least one conduit and at least one sensor configured to determine a condition of the at least one connector and generate a second electrical signal, said at least one sensor being electrically connected to the at least one electrically conductive element such that the second electrical signal is transmitted to the electrical terminal via the electrical signal path, wherein the at least one coil provides a wireless coupling for coupling to the at least one connector and/or the at least one sensor.

24. The detection system according to claim 2, wherein the electrical signal path further comprises a Radio-frequency identification, RFID, chip for transmitting data to or from the electrical terminal and/or the at least one connector.

25. The detection system according to claim 2, wherein the at least one sensor is one or more sensor(s) among: a seal contact pressure sensor, an alignment sensor; an electrical contact sensor in which electrical contacts are made or broken with the connection of the at least one connector; a magnetic sensor in which a magnetic circuit is completed with the connection of the at least one connector; a wireless sensor or an ultrasonic sensor.

26. The detection system according to claim 25, wherein the at least one sensor is embedded in the at least one connector.

27. The detection system according to claim 2, wherein the first electrical signal and the second electrical signals are the same signal.

28. A vehicle comprising the detection system according to claim 1.

29. The vehicle of claim 28, wherein the detection system is part of a positive crankcase ventilation system.

30. A method for detecting a condition of a fluid system using the detection system according to claim 2, and comprising the steps of:
receiving a first electrical signal and/or a second electrical signal from at least one electrically conductive element in the at least one conduit; and
monitoring the first electrical signal and/or the second electrical signal for an electrical characteristic which is indicative of a breakdown of the at least one conduit and/or a disconnection of the at least one connector.

31. The method of claim 30, further comprising: determining a breakdown in the fluid pathway of the fluid system based on a monitored electrical characteristic.

32. The method of claim 31, wherein the electrical characteristic is one or more characteristic(s) chosen from the group comprising: resistance, conductance, capacitance, inductance, frequency response, transit time or amplitude, or change thereof.
